(19) United States
(12) Patent Application Publication
(10) Pub. No.: US 2026/0328378 A1
(43) Pub. Date: Oct. 22, 2026

(54) PIVOTABLE MOUNTING ASSEMBLY FOR LIGHTING DRIVERS

(71) Applicant: SIGNIFY HOLDING B.V., Eindhoven (NL)

(72) Inventor: ROBERT JOSEPH RIFFEL, Byhalia, MS (US)

(21) Appl. No.: 19/569,432

(22) Filed: Mar. 17, 2026

Related U.S. Application Data
(60) Provisional application No. 63/789,475, filed on Apr. 16, 2025.

(51) Int. Cl. F21V 23/00; F21V 17/12; F21Y 115/10

(52) U.S. Cl. CPC F21V 23/008; F21V 17/12; F21V 23/001; F21Y 2115/10

(57) ABSTRACT

A lighting driver for a lighting fixture is disclosed. The lighting driver includes a pivotal mounting assembly including a body, a first coupling feature arranged to couple to a lighting fixture and a second coupling feature arranged to couple to the lighting driver. The body forms a guide path cavity allowing for one or more electrical connections to pass therethrough between the lighting driver and the lighting fixture. The pivotal mounting assembly may be oriented in a first configuration for directly mounting to the lighting fixture and a second configuration for remotely mounting to the lighting fixture. The second coupling feature may include a pivot-type coupling feature that allows the pivotal mounting assembly to be coupled to the lighting driver at a pivoting axis point to allow for the one or more electrical connections pass through an opening in the pivoting axis point and out the guide path cavity.

### FIELD OF THE INVENTION

The invention relates generally to mounting and wiring assemblies for lighting fixtures, and in particular, to a multi-positional/orientational assembly for lighting drivers for a lighting fixture.

### BACKGROUND

LED lighting fixtures require a lighting driver box, or more commonly referred to as an LED or lighting driver, which is a self-contained power supply that regulates power to an LED or a string of LEDs, ensuring they operate efficiently and reliably. The primary role of an LED driver is to convert the incoming power (typically AC) from a standard electrical source into a suitable voltage and current that matches the LED's requirements. LEDs are current-driven devices, meaning they operate most efficiently and have a longer lifespan when supplied with a constant current, rather than a constant voltage. LED drivers also protect LEDs from voltage spikes, fluctuations, and overcurrent, which can damage them.

In some cases, LED drivers are integral, or built into the LED light bulb, especially for LED light bulbs that are meant to plug or screw directly into an existing non-LED fixture. In many cases, such as for commercial lighting fixtures, the LED drivers are a separate box which may be remote, mounted directly to, or within the lighting fixture, similar to a ballast or transformer. In such cases, the electrical connections to lighting fixture may made via a conduit knockout or flexible conduit connection.

Electrical conduit knockouts are pre-punched perforations in the lighting driver box. These knockouts allow for electrical cables, connections or conduits to couple the LED driver to the lighting fixture. For example, such knockouts are designed to accommodate various conduit sizes, typically ½-inch to 2 inches in diameter.

Flexible conduit is a versatile component in modern electrical systems, offering protection and flexibility for wires in various applications. Unlike rigid conduit, flexible conduit can bend and adapt to challenging layouts, making it ideal for spaces with tight corners, irregular shapes, or frequent adjustments. Whether in residential basements, commercial offices, or industrial facilities, flexible conduit safeguards wires from mechanical damage, environmental hazards, and wear and tear.

In this regard, conventional lighting fixtures may include a knockout in the luminaire so that the lighting driver box can be directly coupled to the lighting fixture using a conduit nut. In other configurations, a remote lighting driver box can be coupled to the lighting fixture using a flexible (or rigid) conduit.

A shortcoming of the conventional lighting fixtures discussed above is that only a single configuration is available for the connection to the lighting driver box. This means that the conventional lighting fixture can only accommodate a directly coupled lighting driver box or a remote lighting driver box, but not both types of connections. The correct type of lighting driver box connection must be available at the time of installation or delays will occur.

In addition, this shortcoming does not allow for possible changes/limitations in size, space or environmental considerations at the installation location. Such changes/limitations may mandate that one or the other type of lighting driver box connection configuration be used to couple/install the lighting driver box to the lighting fixture.

A need exists for a lighting driver box mounting assembly that has flexibility to accommodate a direct or remote connection to the lighting fixture.

### SUMMARY OF THE PRESENT INVENTION

Aspects, objects, and embodiments of the present invention address the shortcomings discussed above.

One embodiment of the present invention is directed to a lighting driver for a lighting fixture. The lighting driver has a pivotal mounting assembly that has a body, a first coupling feature arranged to couple to the lighting fixture and a second coupling feature arranged to couple to the lighting driver. The body forms a guide path cavity allowing for one or more electrical connections to pass therethrough between the lighting driver box and the lighting fixture. The pivotal mounting assembly may be oriented in a first configuration for directly mounting to the lighting fixture and a second configuration for remotely mounting to the lighting fixture.

In another embodiment of the pivotal mounting assembly, the second coupling feature includes a pivot-type coupling feature that allows the pivotal mounting assembly to be coupled to the lighting driver box at a pivoting axis point. This allows for the electrical connections pass through an opening in the pivoting axis point and out the guide path cavity.

Another embodiment of the present invention is directed to a lighting fixture including an LED lighting module and an LED driver. The LED driver includes a pivotal mounting assembly having a body, a first coupling feature that can be coupled to the lighting fixture and a second coupling feature is coupled to the LED driver. The body forms a guide path cavity that allows electrical connections to pass therethrough between the LED driver and the lighting fixture. The pivotal mounting assembly may be oriented in a first configuration for directly mounting to the LED fixture and a second configuration for remotely mounting to the LED fixture.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the figures, elements which correspond to elements already described may have the same reference numerals. In the drawings,

FIG. 1 illustrates a perspective view of an example lighting driver box with a pivotal mounting assembly in accordance with one embodiment of the present disclosure;

FIG. 2 illustrates a perspective view of an example pivotal mounting assembly in accordance with one embodiment of the present disclosure;

FIGS. 3a, 3b and 3c illustrate a perspective view, top view and a side view, respectively, of an example lighting driver box in a first configuration in accordance with an embodiment of the present disclosure; and

FIGS. 4a, 4b and 4c illustrate a perspective view, a top view and a side view, respectively, of an example lighting driver box in a second configuration in accordance with an embodiment of the present disclosure.

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

In the following paragraphs, the present disclosure will be described in further detail by way of examples with reference to the attached drawings. In the description, well known components, methods, and/or techniques are omitted or briefly described so as not to obscure the disclosure. As used herein, the “present disclosure” and/or “present invention” refers to any one of the embodiments of the disclosure described herein and any equivalents. Furthermore, the reference to various feature(s) of the “present disclosure” is not to suggest that all embodiments must include the referenced feature(s).

The disclosure provides example embodiments of lighting driver boxes with a pivotal mounting assembly. The embodiments described herein are merely examples and variations on the examples provided herein are encompassed within this disclosure.

It should be understood that the embodiments described herein can apply to a variety of luminaires. For example, the embodiments can be used with luminaires located in different types of environments, e.g., commercial or residential. Further, the luminaires described herein can use one or more of a number of different types of light sources, including but not limited to various light-emitting diode (LED) lighting modules such as discrete LEDs, LED bars, LED arrays, chip on board LEDs, and organic LED light sources, as well as other types of light sources. Therefore, the example luminaires described herein should not be considered limited to a particular type of light source.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The example lighting fixtures described herein can comprise a variety of components. Such components can be mechanically coupled to each other using one or more of a number of coupling methods or coupling features, including but not limited to adhesives, welding, fastening devices, compression fittings, mating threads, snap-fit and slotted fittings. One or more pieces that are mechanically coupled to each other can be coupled to each other in one or more of a number of ways, including but not limited to, fixedly, hingedly, removeably, slidably, and threadably. Such terms are merely meant to distinguish various elements and/or features within a component or device and are not meant to limit the capability or function of that particular element and/or feature. For example, a feature described as “coupled to” or a “coupling feature” can be coupled, secured, fastened, and/or perform other functions aside from merely coupling. In addition, each component and/or feature described herein (including each component of an example flow-through luminaire) can be made of one or more of a number of suitable materials, including but not limited to metal, ceramic, rubber, and plastic.

Some building construction techniques enable relatively tight plenum spaces that can pose challenges for lighting installation and wiring. At the same time, the need for increased light output requires relatively large power supplies that pose additional installation challenges. Some of these challenges may not be known at the time of obtaining/ordering all the necessary installation parts and lighting fixtures. For example, limited plenum space along with light fixture openings that are limited in size can make installation of lighting driver boxes challenging and which may require changing the installation requirements. In some example embodiments, the present invention alleviates some or all of such challenges.

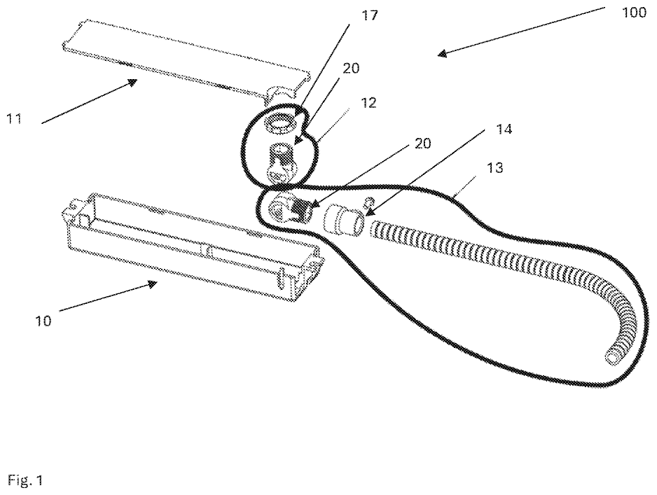

Referring now to FIG. 1, an example lighting driver 100 is illustrated. The lighting driver 100 includes a housing 10 and a top 11. Although the housing 10 has a rectangular shape in the example of FIG. 1, in alternate embodiments the housing 10 can have a variety of other shapes. The top 11 may be removably coupled to the housing 10. The housing 10 includes one or more components (not shown) necessary for proper operation of a lighting fixture (not shown). For example, such one or more components may include a circuit board, a battery and a lightguide interface. Such one or more components enable proper operation of the lighting fixture. A pivotal mounting assembly 20 is shown in two configurations. A first configuration 12 is shown for a direct mount configuration to the lighting fixture. A second configuration 13 is shown for a remote mount configuration to the lighting fixture.

In the first configuration 12, the pivotal mounting assembly 20 is shown in a 90-degree orientation from the plane formed by the top 11. In the second configuration 13, the pivotal mounting assembly 20 is shown in a parallel orientation from the plane formed by the top 11. It should be understood by one of ordinary skill in the art that other orientations/angles from the plane formed by the top 11 may also be used.

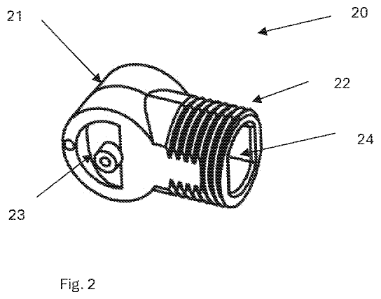

As shown in FIG. 2, the pivotal mounting assembly 20 includes a body 21, a first coupling feature 22 and a second coupling feature 23. In embodiment of FIG. 2, the body 21 forms a hollow/drum-like structure that forms a guide path cavity 24. While the body 21 has a drum-like shape in the example of FIG. 2, in alternate embodiments the body 21 can have a variety of other shapes. The guide path cavity 24 allows for one or more electrical connections to pass therethrough between the lighting driver 100 and the lighting fixture.

The first coupling feature 22 is used to couple the lighting driver 100 directly or remotely to the lighting driver 100. As shown in FIGS. 1 and 2, the first coupling feature 22 may include a threaded end to couple to a threaded connector 14 or threaded nut 17. Although it should be understood that other types of coupling features may be used.

The second coupling feature 23 is used to couple the pivotal mounting assembly 20 to the lighting driver 100. In the example shown in FIGS. 1 and 2, the second coupling feature 23 may include a pivot-type coupling feature. This type of pivot-type coupling feature allows two objects to be joined at a pivoting axis point, enabling one object to rotate or pivot around that point relative to the other. As shown in this example, the second coupling feature 23 is designed to provide a point of rotation of the opening of the guide path cavity 24 in a parallel or perpendicular orientation (or cone angle) relative to the top 11 of the lighting driver 100. The electrical connections needed between the lighting drive 100 and the lighting fixture may pass through an opening in the pivoting axis point and out the guide path cavity 24. It is noted that other or adjustable cone angles may also be used as needed for a particular installation. In addition, other types of moveable, rotatable or adjustable coupling features may be used.

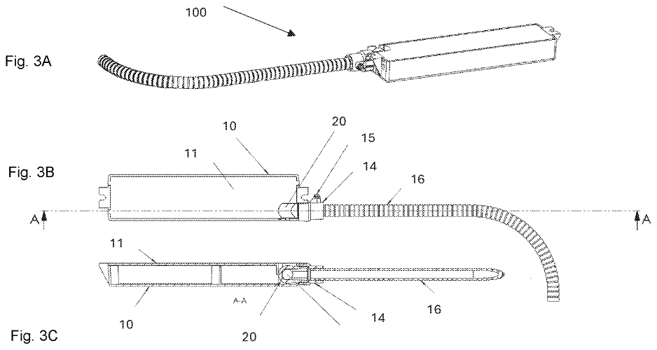

FIGS. 3a, 3b and 3c show a perspective view, top view and a side view, respectively, of an example lighting driver 100 when used to couple remotely to the lighting fixture. In this example, the pivotal mounting assembly 20 in an orientation that is generally parallel to the top 11 of the lighting driver 100. The first coupling feature 22 is coupled to the threaded connector 14 which is used to couple to a conduit 16 (e.g. flexible or ridge). In this example, the conduit 16 is secured to the threaded connector 14 using a screw 15.

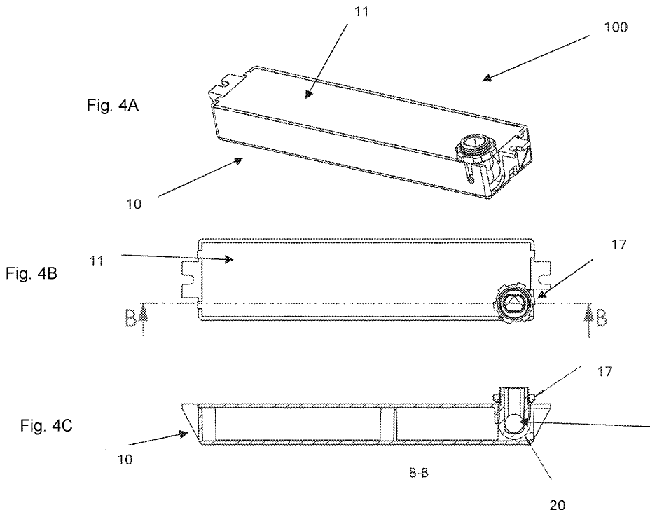

FIGS. 4a, 4b and 4c show a perspective view, a top view and a side view, respectively, of an example lighting driver 100 when used to directly couple to the lighting fixture. In this example, the pivotal mounting assembly 20 in an orientation that is generally perpendicular to the top 11 of the lighting driver 100. The first coupling feature 22 is coupled to the threaded nut 17 which is used to secure the lighting driver 100 to the lighting fixture.

The foregoing detailed description has set forth a few of the many forms that the invention can take. The above examples are merely illustrative of several possible embodiments of various aspects of the present invention, wherein equivalent alterations and/or modifications will occur to others skilled in the art upon reading and understanding the present invention and the annexed drawings. In particular, with regard to the various functions performed by the above described components, the terms used to describe such components are intended to correspond, unless otherwise indicated to any component, such as hardware or combinations thereof, which performs the specified function of the described component (i.e., that is functionally equivalent), even though not structurally equivalent to the disclosed structure which performs the function in the illustrated implementations of the disclosure.

Although a particular feature of the present invention may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items. Also, to the extent that the terms “including”, “includes”, “having”, “has”, “with”, or variants thereof are used in the detailed description and/or in the claims, such terms are intended to be inclusive in a manner similar to the term “comprising”.

The present invention has been described with reference to the preferred embodiments. However, modifications and alterations will occur to others upon reading and understanding the preceding detailed description. It is intended that the present invention be construed as including all such modifications and alterations. It is only the claims, including all equivalents that are intended to define the scope of the present invention.

In the claims references in parentheses refer to reference signs in drawings of exemplifying embodiments or to formulas of embodiments, thus increasing the intelligibility of the claim. These references shall not be construed as limiting the claim.

1. A lighting driver for a lighting fixture, comprising:
a pivotal mounting assembly including a body, a first coupling feature arranged to couple to a lighting fixture and a second coupling feature arranged to couple to the lighting driver,
wherein the body forms a guide path cavity allowing for one or more electrical connections to pass therethrough between the lighting driver and the lighting fixture, and
wherein the pivotal mounting assembly may be oriented in a first configuration for directly mounting to the lighting fixture and a second configuration for remotely mounting to the lighting fixture.

2. The lighting driver of claim 1, further comprising a top, wherein in the first configuration the pivotal mounting assembly is in a 90-degree orientation from the plane formed by the top and in the second configuration, the pivotal mounting assembly is in a parallel orientation from the plane formed by the top.

3. The lighting driver of claim 1, wherein the body includes a hollow/drum-like structure that forms the guide path cavity.

4. The lighting driver of claim 1 wherein the first coupling feature includes a threaded end to couple to a threaded connector or threaded nut.

5. The lighting driver of claim 1, wherein the second coupling feature include a pivot-type coupling feature that allows the pivotal mounting assembly to be coupled to the lighting driver at a pivoting axis point.

6. The lighting driver of claim 5, wherein the one or more electrical connections pass through an opening in the pivoting axis point and out the guide path cavity.

7. The lighting driver of claim 1, wherein an orientation of the first coupling feature is rotatable or adjustable.

8. The lighting driver of claim 1, wherein in the second configuration the lighting driver may be remotely mounted to the lighting fixture using a flexible or rigid conduit.

9. The lighting driver of claim 1, wherein in the first configuration the lighting driver may be directly mounted to the lighting fixture using a threaded nut.

10. A lighting fixture, comprising:
an LED lighting module; and
an LED driver including a pivotal mounting assembly including a body, a first coupling feature arranged to couple to a lighting fixture and a second coupling feature arranged to couple to the LED driver, wherein the body forms a guide path cavity allowing for one or more electrical connections to pass therethrough between the LED driver and the lighting fixture, and wherein the pivotal mounting assembly may be oriented in a first configuration for directly mounting to the lighting fixture and a second configuration for remotely mounting to the lighting fixture.

11. The lighting fixture of claim 10, wherein the LED driver further comprising a removable top, wherein in the first configuration the pivotal mounting assembly is in a 90-degree orientation from the plane formed by the top and in the second configuration, the pivotal mounting assembly is in a parallel orientation from the plane formed by the top.

12. The lighting fixture of claim 10, wherein the body of the pivotal mounting assembly includes a hollow/drum-like structure that forms the guide path cavity.

13. The lighting fixture of claim 10, wherein the first coupling feature includes a threaded end to couple to a threaded connector or a threaded nut.

14. The lighting fixture of claim 10, wherein the second coupling feature include a pivot-type coupling feature that allows the pivotal mounting assembly to be coupled to the LED driver at a pivoting axis point.

15. The lighting fixture of claim 14, wherein the one or more electrical connections pass through an opening in the pivoting axis point and out the guide path cavity.

16. The lighting fixture of claim 10, wherein an orientation of the first coupling feature is rotatable or adjustable.

17. The lighting fixture of claim 10, wherein in the second configuration the LED driver may be remotely mounted to the lighting fixture using a flexible or rigid conduit.

18. The lighting fixture of claim 10, wherein in the first configuration the LED driver may be directly mounted to the lighting fixture using a threaded nut.
